(19) United States
(12) Patent Application Publication
(10) Pub. No.: US 2008/0049002 A1
(43) Pub. Date: Feb. 28, 2008

(54) Scan line driving method

(75) Inventors: Lin Lin, Taichung (TW); Bau-Jy Liang, Hsinchu (TW); Chun-Ming Huang, Taichung (TW); Chih-Chang Lai, Taichung (TW); Tai-Yuan Chen, Taichung (TW); Shen-Ping Chiang, Kaohsiung (TW)

Correspondence Address: BACON & THOMAS, PLLC, 625 SLATERS LANE, FOURTH FLOOR, ALEXANDRIA, VA, 22314, US

(73) Assignee: Wintek Corporation, TAICHUNG (TW)

(21) Appl. No.: 11/892,446

(22) Filed: Aug. 23, 2007

(30) Foreign Application Priority Data
Aug. 24, 2006 (TW) 95131192

(51) Int. Cl. G09G 5/00

(52) U.S. Cl. 345/205

(57) ABSTRACT

A scan line driving method of a liquid crystal display divides scan times of a first scan line and a second scan line so that enabled times of the first scan line and the second scan line respectively equal a charge time and a discharge time. The first scan line and the second scan line respectively control a first row of pixels and a second row of pixels of the liquid crystal display.

This application claims the benefit of Taiwan application Serial No. 95131192, filed Aug. 24, 2006, the subject matter of which is incorporated herein by reference.

### BACKGROUND OF THE INVENTION

1. Field of the Invention

The invention relates in general to a scan line driving method, and more particularly to a scan line driving method in a liquid crystal display.

2. Description of the Related Art

FIG. 1 (Prior Art) is a circuit block diagram showing a conventional liquid crystal display 100. Referring to FIG. 1, the liquid crystal display 100 includes a data line driving circuit 102, a scan driving circuit 104, N rows of pixels 106, multiple data lines 108 and N scan lines 110, wherein N is a natural number greater than 1.

The scan driving circuit 104 outputs N scan signals through the N scan lines to drive the N rows of pixels 106, respectively. The data line driving circuit 102 outputs pixel data through the data lines 108. The pixel 106 includes a thin film transistor (TFT) 106a and a storage capacitor CS. The TFT 106a has one terminal coupled to the storage capacitor CS, the other terminal coupled to the data line 108, and a control terminal coupled to the scan line 110.

FIG. 2 (Prior Art) is a timing chart showing scan signals for the conventional scan lines. As shown in FIG. 2, the scan signals SD1 to SDN respectively drive the N scan lines 110 of the liquid crystal display 100. The scan signals SD1 to SDN have the same enabled time length, and are sequential enabled. The N scan lines 110 drive the N rows of pixels 106 to store the pixel data on the data lines 108 into the storage capacitor CS when the scan signals SD1 to SDN are enabled.

The conventional scan line driving method drives the scan lines of the display using the sequential scan signals having the same enabled time. With the rapidly growing resolution of the liquid crystal display, however, the scan time of each scan line is shortened within the same frame period according to the conventional scan line driving method. Thus, the voltage of the storage capacitor in the pixel cannot reach the data voltage level to be written due to the too-short charge time, and the display effect becomes poor. If the charging speeds of the data lines are increased by increasing the size of the TFT, the aperture ratio of the liquid crystal display tends to decrease.

### SUMMARY OF THE INVENTION

The invention is directed to a scan line driving method for enhance the precision of a data voltage of a pixel and to shorten a data writing time of the pixel.

According to a first aspect of the present invention, a scan line driving method is provided. The method divides scan times of scan lines in a liquid crystal display into a charge time and a discharge time. The liquid crystal display includes a first scan line, a second scan line, a first row of pixels and a second row of pixels. The first scan line and the second scan line respectively control the first row of pixels and the second row of pixels. The scan line driving method includes the following steps. First, the first scan line is enabled in the charge time to drive the first row of pixels to charge. Next, the second scan line is enabled in the discharge time to drive the second row of pixels to discharge. In a next frame, the first scan line is enabled in the discharge time to drive the first row of pixels to discharge. Thereafter, the second scan line is enabled in the charge time to drive the second row of pixels to charge.

According to a second aspect of the present invention, a scan line driving method is provided. The method divides scan times of scan lines of a liquid crystal display. The liquid crystal display includes a first scan line, a second scan line, a first row of pixels and a second row of pixels. The first scan line and the second scan line respectively control the first row of pixels and the second row of pixels. The scan line driving method includes the following steps. First, the scan times of the first scan line and the second scan line are divided into a predetermined voltage setting time, a first scan time and a second scan time. Then, the first scan line and the second scan line are enabled in the predetermined voltage setting time to make voltages of the first row of pixels and the second row of pixels equal to a predetermined voltage. Furthermore, the first scan line and the second scan line are respectively enabled in the first scan time and the second scan time to respectively input corresponding data voltages to the first row of pixels and the second row of pixels. Then, the above-mentioned steps are repeated.

According to a third aspect of the present invention, a scan line driving method is provided. The method divides scan times of scan lines of a liquid crystal display. The liquid crystal display includes N scan lines and N rows of pixels, wherein N is a natural number greater than 1. The N scan lines respectively control the N rows of pixels. The scan line driving method includes the following steps. First, N scan times of the N scan lines are divided into a predetermined voltage setting time and N data input times. Then, the N scan lines are enabled in the predetermined voltage setting time to make voltages of the N rows of pixels be equal to a predetermined voltage. Furthermore, the N scan lines are enabled in the N data input times, respectively, to input corresponding data voltages to the N rows of pixels. Then, the above-mentioned steps are repeated. The predetermined voltage setting time and the N data scan times do not overlap with one another.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a circuit block diagram showing a conventional liquid crystal display.

FIG. 2 (Prior Art) is a timing chart showing scan signals for conventional scan lines.

FIG. 3 is a circuit block diagram showing a dual-side scanning liquid crystal display.

FIG. 4 shows waveforms of scan signals in a scan line driving method according to a first embodiment of the invention.

FIG. 5 is an experimental chart showing liquid crystal capacitor being charged and discharged.

FIG. 6 is a flow chart showing a method for driving the scan lines according to the first embodiment of the invention.

FIG. 7 shows waveforms of scan signals in a scan line driving method according to a second embodiment of the invention.

FIG. 8 shows waveforms of positive frame pixel voltages in the liquid crystal display driven by the scan signals of FIG. 7.

FIG. 9 shows waveforms of negative frame pixel voltages in the liquid crystal display driven by the scan signals of FIG. 7.

FIG. 10 is a flow chart showing a method for driving the scan lines according to the second embodiment of the invention.

FIG. 11 shows waveforms of scan signals in a scan line driving method according to a third embodiment of the invention.

FIG. 12 shows waveforms of pixel voltages in the liquid crystal display driven by the scan signals of FIG. 11.

FIG. 13 is a flow chart showing the scan line driving method according to the third embodiment of the invention.

FIG. 14 shows a waveform of a Gamma curve in the driving method for the invention.

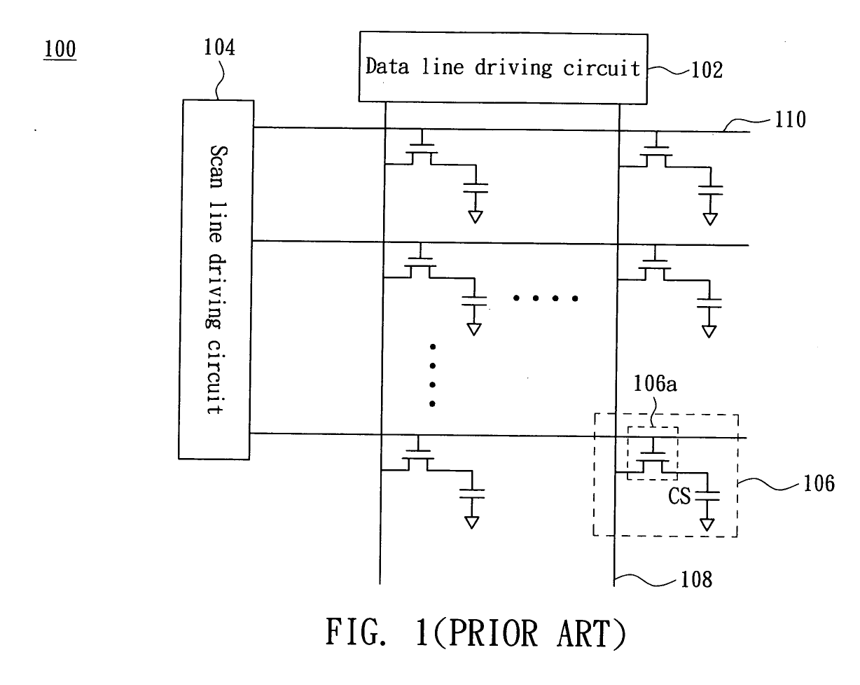

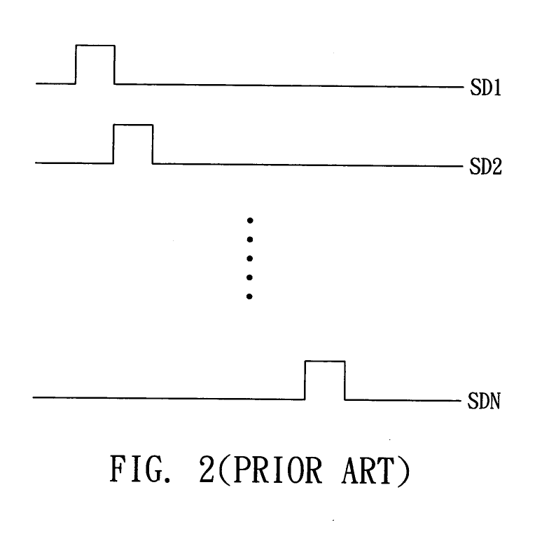

### DETAILED DESCRIPTION OF THE INVENTION

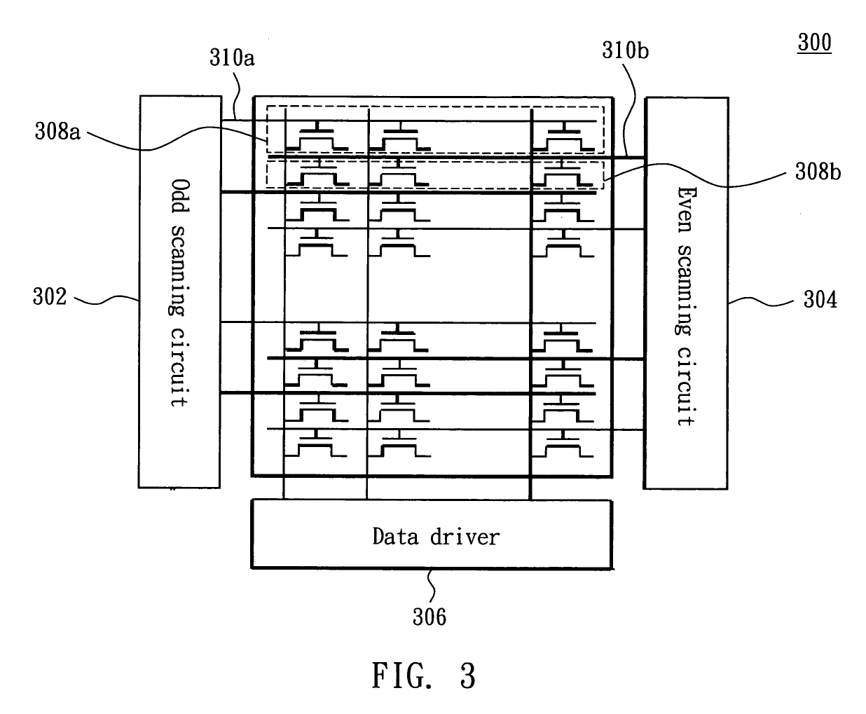

FIG. 3 is a circuit block diagram showing a dual-side scanning liquid crystal display 300. Referring to FIG. 3, the liquid crystal display 300 includes an odd scanning circuit 302, an even scanning circuit 304, a data driver 306, N rows of pixels 308 and N scan lines 310, wherein N is a natural number greater than 1. The N rows of pixels 308 include corresponding storage capacitors (not shown). The N scan lines 310 include odd scan lines 310a and even scan lines 310b.

The odd scanning circuit 302 and the even scanning circuit 304 scan odd-numbered rows of pixels 308a and even-numbered rows of pixels 308b in the N rows of pixels 308 through the odd scan lines 310a and the even scan lines 310b, respectively, wherein the scan time of each scan line is equal to a pixel scanning time TS. The scan line driving method according to the invention is applied to the liquid crystal display 300. The detailed implementing methods of the invention will be described with reference to the following three embodiments.

### First Embodiment

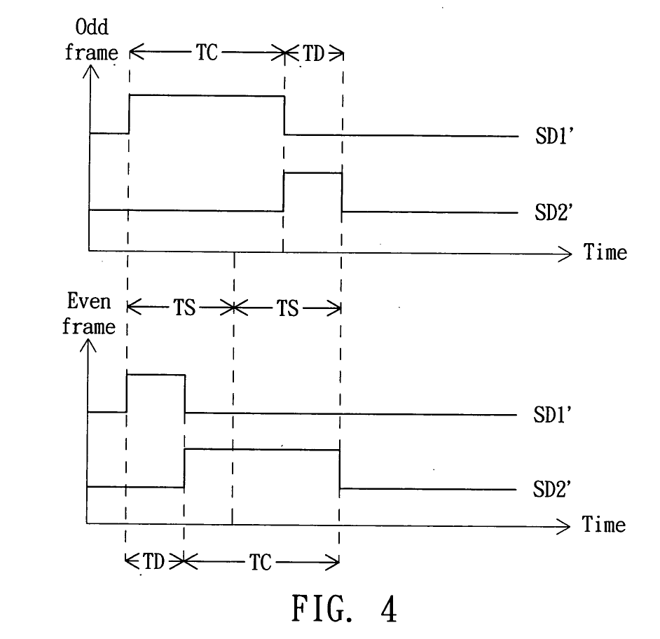

FIG. 4 shows waveforms of scan signals in the scan line driving method according to a first embodiment of the invention. As shown in FIG. 4, two scan signals SD1′ and SD2′ are illustrated in this embodiment to describe the scan signals for driving the odd scan lines 310a and the even scan lines 310b.

As shown in FIG. 4, this embodiment is applied to the liquid crystal display 300, and the odd scanning circuit 302 and the even scanning circuit 304 respectively generate the scan signals SD1′ and SD2′. The scan signals SD1′ and SD2′ control the odd-numbered rows of pixels 308a and the even-numbered rows of pixels 308b through the odd scan lines 310a and the even scan lines 310b.

The liquid crystal display 300 includes an odd frame scanning period and an even frame scanning period due to the inversion of the data voltage polarity. In the odd frame scanning period, the odd-numbered rows of pixels 308a are in a charge state and the even-numbered rows of pixels 308b are in a discharge state. In the even frame scanning period, the odd-numbered rows of pixels 308a are in the discharge state and the even-numbered rows of pixels 308b are in the charge state. The odd-numbered rows of pixels 308a and the even-numbered rows of pixels 308b have different data voltage polarities, and the polarity of the pixel data is changed every two frame scanning periods. This liquid crystal display 300 is preferable a row inversion liquid crystal display.

The embodiment divides the pixel scanning times TS of the odd scan lines 310a and the even scan lines 310b of the N scan lines 310 so that the enabled times of the scan signal SD1′ in the odd frame scanning period and the even frame scanning period are respectively a charge time TC and a discharge time TD, and the enabled times of the scan signal SD2′ in the odd frame scanning period and the even frame scanning period are the discharge time TD and the charge time TC, respectively.

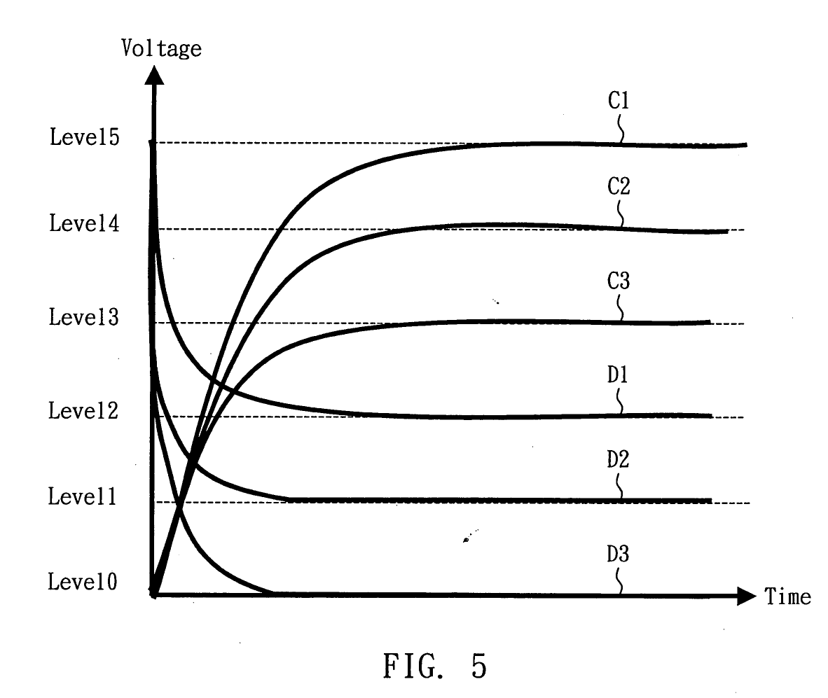

The scan signals SD1′ and SD2′ change the length of the enabled time once every one frame scanning period with the changes of the charge states or the discharge states of the odd-numbered rows of pixels 308a and the even-numbered rows of pixels 308b. This charge time is equal to 4/3 times of the pixel scanning time TS, and the discharge time is equal to 2/3 times of the pixel scanning time TS. FIG. 5 is an experimental simulation chart showing a capacitor being charged and discharged. As shown in FIG. 5, the charge time needed for charging the liquid crystal capacitor from a lower voltage level to a higher voltage level is substantially equal to two times of the time needed for discharging the capacitor from the higher voltage level to the lower voltage level. In this embodiment, the pixel scanning times of the N scan lines 310 are divided into the charge time TC and the discharge time TD. The N/2 scan lines 310 control the shortening of the discharge time of the pixel in the discharge state, and the other N/2 scan lines 310 control the lengthening of the charge time of the pixel in the charge state so that the precision of the pixel voltage is enhanced.

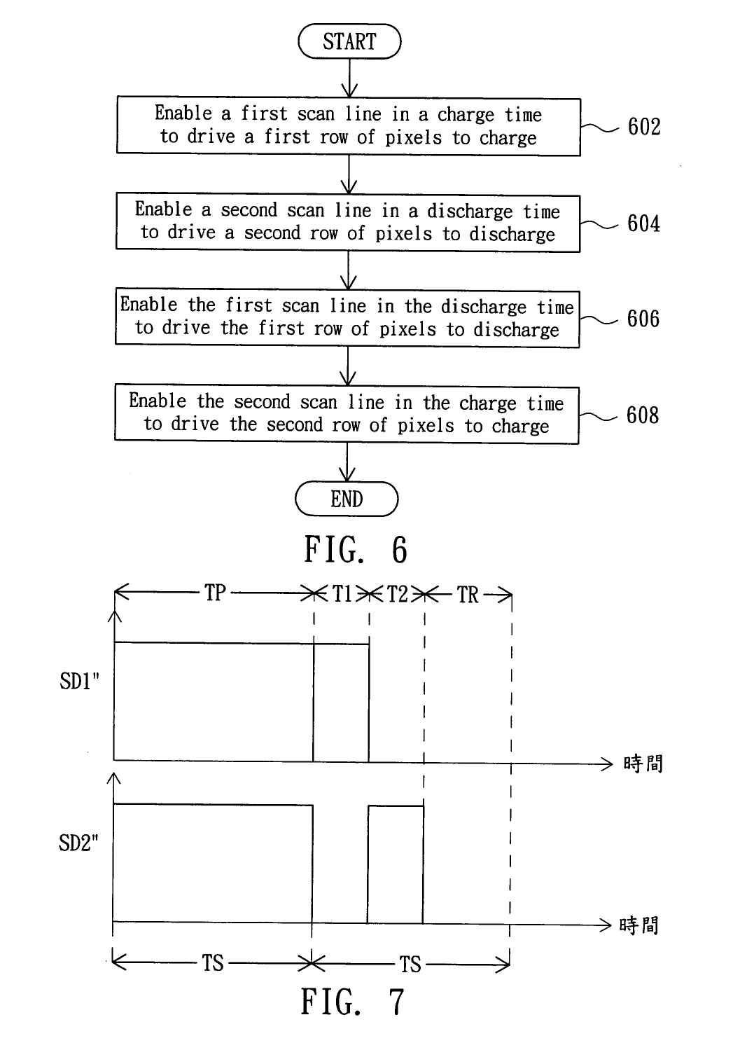

FIG. 6 is a flow chart showing a method for driving the scan lines according to the first embodiment of the invention. As shown in FIG. 6, illustrations are made according to the condition that the first scan line represents the odd scan line 310a and the second scan line represents the even scan line 310b, for example. The operation flow of this embodiment will be described in the following.

First, step 602 enables the first scan line in the charge time to drive the first row of pixels to charge.

Then, step 604 enables the second scan line in the discharge time to drive the second row of pixels to discharge.

Next, step 606 enables the first scan line in the discharge time to drive the first row of pixels to discharge.

Then, step 608 enables the second scan line in the charge time to drive the second row of pixels to charge.

This embodiment divides the pixel scanning times of the N scan lines 310 according to the charge/discharge states of the N rows of pixels 308. Thus, this embodiment lengthens the operation times of the N/2 rows of pixels 308 in the charge states so that the rows of pixels 308 may be sufficiently charged to the set voltage, and shortens the operation times of the N/2 rows of pixels in the discharge states so that the sum of the pixel scanning times of the N scan lines 310 is kept constant. This embodiment may also be applied to the typical single-side scanning circuit, or other liquid crystal displays.

The scan line driving method according to the first embodiment of the invention can shorten the discharge times of the rows of pixels of the liquid crystal display so as to enhance the operating efficiency of the pixel and to lengthen the charge times of the rows of pixels. Thus, the problem of the incorrect data voltage level or the reduction of the aperture ratio due to the increase of the size of the TFT in the conventional liquid crystal display can be solved.

### Second Embodiment

FIG. 7 shows waveforms of scan signals in a scan line driving method according to a second embodiment of the invention. As shown in FIG. 7, the scan signals SD1″ and SD2″ respectively represent the scan signals for driving the odd scan lines 310a and the even scan lines 310b in this embodiment, and the scan signals SD1″ and SD2″ of the odd scan lines 310a and the even scan lines 310b will be described in the following, for example.

The difference between the second embodiment and the first embodiment is that the scan signals SD1 and SD2″ of the second embodiment and the scan signals SD1′ and SD2′ of the first embodiment have different timing waveforms. As shown in FIG. 7, the scan line driving method of this embodiment divides the pixel scanning times TS of the odd scan lines 310a and the even scan lines 310b of the N scan lines 310 so that the enabled times of the scan signal SD1″ include a predetermined voltage setting time TP and an odd scan time T1. The enabled times of the scan signal SD2″ include the predetermined voltage setting time TP and an even scan time T2. The predetermined voltage setting time TP, the odd scan time T1 and the even scan time T2 do not overlap with one another.

The scan signals SD1″ and SD2″ control the odd-numbered rows of pixels 308a and the even-numbered rows of pixels 308b through the odd scan lines 310a and the even scan lines 310b to drive the N rows of pixels 308 to achieve the pre-charge and pre-discharge effects. This liquid crystal display 300 is a two-row inversion liquid crystal display.

For example, the predetermined voltage setting time TP is equal to the pixel scanning time TS, and the odd scan time T1 and the even scan time T2 are shorter than the pixel scanning time TS. A sum of the predetermined voltage setting time TP, the odd scan time T1 and the even scan time T2 is preferably smaller than a sum of two pixel scanning times TS. In addition, a difference between the sum of the predetermined voltage setting time TP, the odd scan time T1 and the even scan time T2 and the sum of the two pixel scanning times TS is equal to a saved time TR. The actual applications of the scan signals SD1″ and SD2″ will be described with reference to the accompanying drawing.

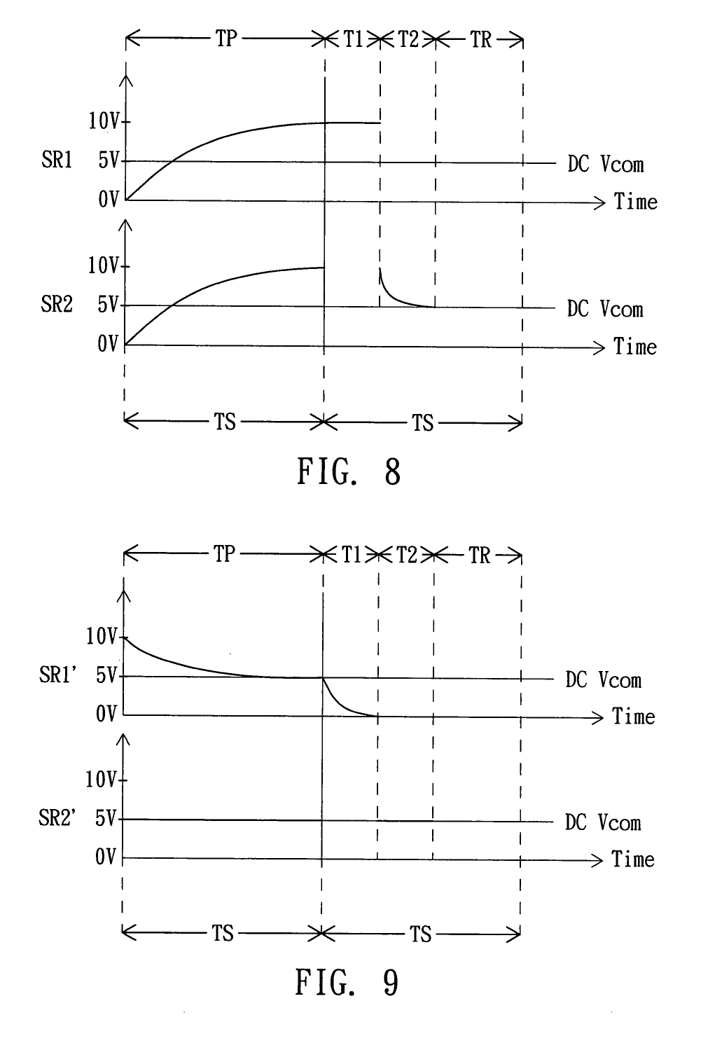

FIG. 8 shows waveforms of positive frame pixel voltages in the liquid crystal display driven by the scan signals of FIG. 7. As shown in FIG. 8, the pixel voltages SR1 and SR2 are respectively the voltages at non-common voltage terminals of the storage capacitors of the odd-numbered rows of pixels 308a and the even-numbered rows of pixels 308b. The initial voltages of the pixel voltages SR1 and SR2 are 0 volts. The data driver 306 outputs data voltages V1 and V2, which are to be written into the odd-numbered rows of pixels 308a and the even-numbered rows of pixels 308b, respectively. The data voltages V1 and V2 may be 10 volts and 5 volts, for example. The voltages at common voltage terminals of the storage capacitors of the liquid crystal display 300 are DC voltages with 5 volts.

In the predetermined voltage setting time TP, the scan signals SD1″ and SD2″ are enabled so that the odd-numbered rows of pixels 308a and the even-numbered rows of pixels 308b are enabled respectively through the odd scan lines 310a and the even scan lines 310b. At this time, the data driver 306 outputs the higher data voltage between the data voltages V1 and V2. In FIG. 8, the higher data voltage is the data voltage V1, for example. At this time, the data voltage V1 charges the storage capacitors of the odd-numbered rows of pixels 308a and the even-numbered rows of pixels 308b so as to start to charge the pixel voltages SR1 and SR2 to the data voltage V1.

In the odd scan time T1, the scan signal SD1″ is enabled so as to enable the odd-numbered rows of pixels 308a through the odd scan lines 310a. At this time, the data driver 306 outputs the data voltage V1 to charge the storage capacitors of the odd-numbered rows of pixels 308a to 10 volts. In the even scan time T2, the scan signal SD2″ is enabled to enable the even-numbered rows of pixels 308b through the even scan lines 310b. At this time, the data driver 306 outputs the data voltage V2 to discharge the storage capacitors of the even-numbered rows of pixels 308b to 5 volts.

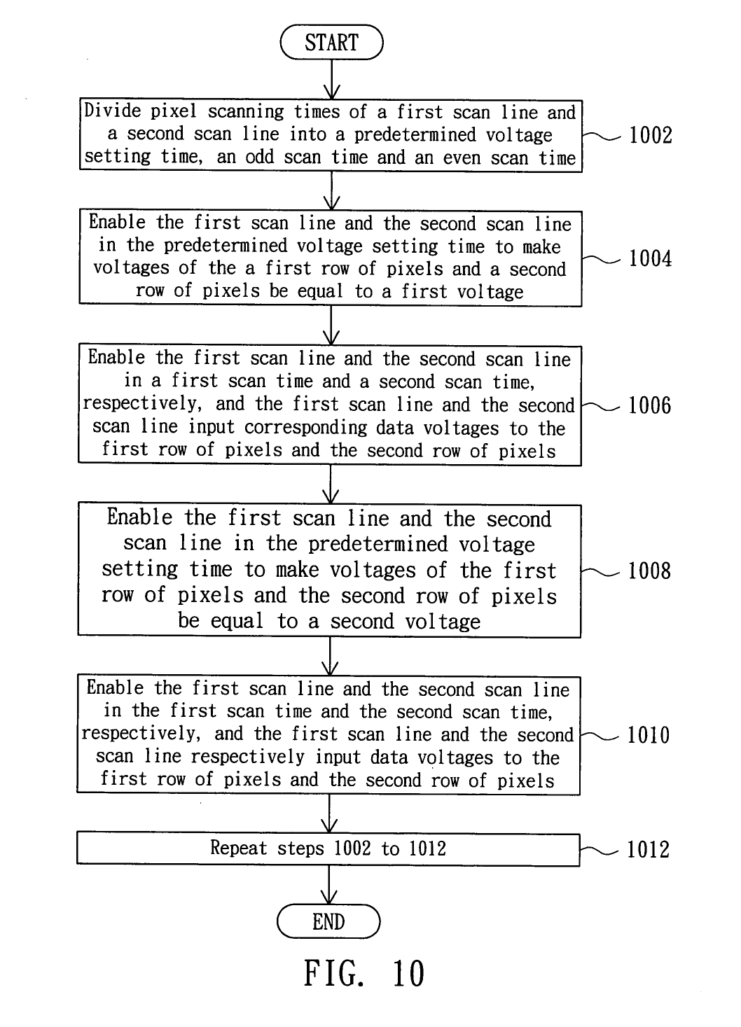

The above-mentioned descriptions are made according to the pixel voltage with the scanning period of the positive voltage frame in the driving waveforms of FIG. 7. However, the embodiment of the driving waveforms of the scan lines of FIG. 7 may further include a scanning period of a negative voltage frame, which is to be described with reference to FIGS. 9 and 10.

FIG. 9 shows waveforms of negative frame pixel voltages in the liquid crystal display driven by the scan signals of FIG. 7. As shown in FIG. 9, the initial voltages of the pixel voltages SR1′ and SR2′ are 10 volts and 5 volts, respectively. The data voltages V1′ and V2′ outputted from the data driver 306 are 0 and 5 volts, respectively.

In the predetermined voltage setting time TP, the scan signals SD1″ and SD2″ are enabled to enable the odd-numbered rows of pixels 308a and the even-numbered rows of pixels 308b through the odd scan lines 310a and the even scan lines 310b, respectively. At this time, the data driver 306 outputs the higher data voltage between the data voltages V1′ and V2′. The higher data voltage discharges the storage capacitors of the odd-numbered rows of pixels 308a and the even-numbered rows of pixels 308b simultaneously. In this embodiment, the higher data voltage between the data voltages V1′ and V2′ is the data voltage V1′, which is 5 volts. Thus, the pixel voltages SR1′ and SR2′ are discharged from 10 and 5 volts to 5 volts.

In the odd scan time T1, the scan signal SD1″ is enabled to enable the odd-numbered rows of pixels 308a through the odd scan lines 310a. At this time, the data driver 306 outputs the data voltage V1′ to discharge the storage capacitors of the odd-numbered rows of pixels 308a. At this time, the pixel voltage SR1′ is discharged from 5 volts to 0 volts. In the even scan time T2, the scan signal SD2″ is enabled to enable the even-numbered rows of pixels 308b through the even scan lines 310b. At this time, the data driver 306 outputs the data voltage V2′ to continuously discharge the storage capacitors of the even-numbered rows of pixels 308b to 5 volts.

The liquid crystal display 300 of this embodiment is a normal white display, for example. Although this embodiment is illustrated by taking the dual-side scanning circuit including the odd scanning circuit 302 and the even scanning circuit 304 as an example. However, the scan line driving method of this embodiment may also be applied to the typical single-side scanning circuit, or other liquid crystal displays.

This embodiment divides every two pixel scanning times TS of the N scan lines 310 of the liquid crystal display 300 into the predetermined voltage setting time TP, the odd scan time T1 and the even scan time T2. The N scan lines 310 are paired according to the method of dividing the scan times TS in order to finish the scanning of the corresponding two rows of pixels in the predetermined voltage setting time TP, the odd scan time T1 and the even scan time T2. Thus, the effect of shortening the scan times of the rows of pixels can be achieved. The shortened scan time of two rows of pixels is equal to the saved time TR.

FIG. 10 is a flow chart showing a method for driving the scan lines according to the second embodiment of the invention, wherein the first scan line represents the odd scan line 310a and the second scan line represents the even scan line 310b. The operating flow of this embodiment will be described in the following.

First, step 1002 divides the pixel scanning times of the first scan line and the second scan line into a predetermined voltage setting time, an odd scan time and an even scan time.

Next, step 1004 enables the first scan line and the second scan line in the predetermined voltage setting time to make the voltages of the first row of pixels and the second row of pixels be equal to a first voltage. The first voltage is the higher one of the data voltages of the first row of pixels and the second row of pixels.

Furthermore, step 1006 enables the first scan line and the second scan line in the first scan time and the second scan time, respectively. The first scan line and the second scan line input the corresponding data voltages to the first row of pixels and the second row of pixels, respectively.

Then, step 1008 enables the first scan line and the second scan line in the predetermined voltage setting time to make the voltages of the first row of pixels and the second row of pixels equal to a second voltage. The second voltage is the higher one of the data voltages of the first row of pixels and the second row of pixels.

Furthermore, step 1010 enables the first scan line and the second scan line in the first scan time and the second scan time, respectively. The first scan line and the second scan line input the data voltages to the first row of pixels and the second row of pixels, respectively.

Thereafter, step 1012 repeats steps 1002 to 1010.

The scan line driving method according to the embodiment of the invention utilizes the pre-charge and pre-discharge methods to shorten the operation times for charging and discharging the data voltages of the liquid crystal display. Thus, the conventional problem of the incorrect data voltage level caused by the insufficient charge time of the data voltage in the conventional liquid crystal display or the reduction of the aperture ratio caused by the increase of the size of the TFT can be solved.

### Third Embodiment

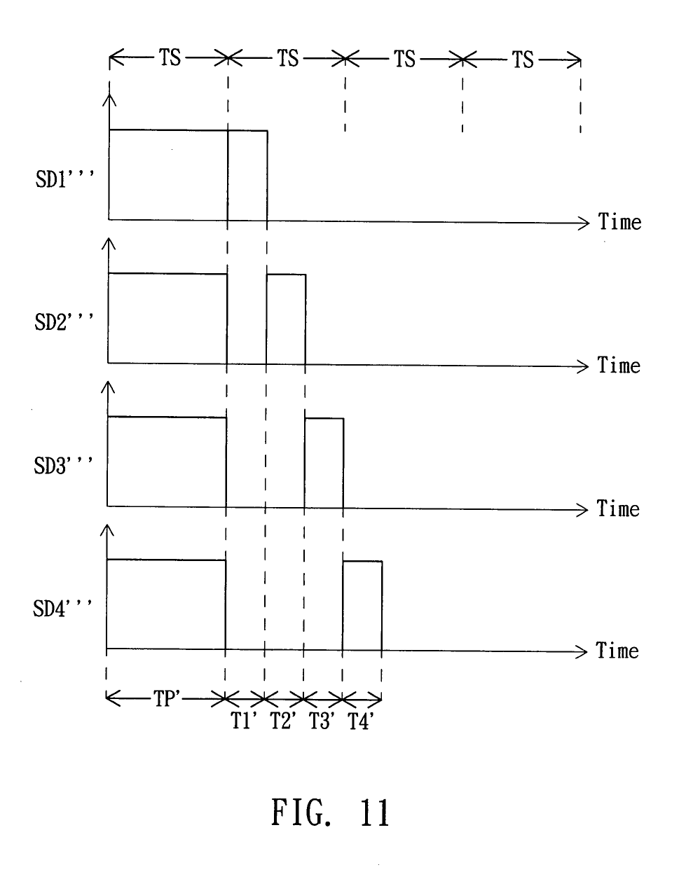

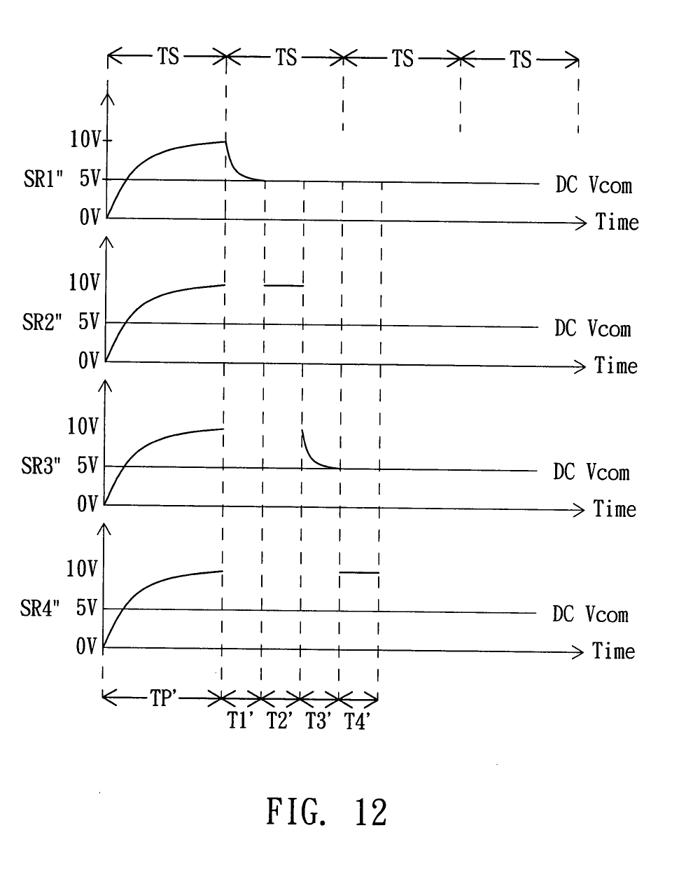

FIG. 11 shows waveforms of scan signals in a scan line driving method according to a third embodiment of the invention. As shown in FIG. 11, the scan line driving method according to the third embodiment is applied to the liquid crystal display 300. This embodiment adopts the method of dividing the pixel scanning times TS of the N scan lines 310 of the liquid crystal display 300 to control the N rows of pixels 308 of the liquid crystal display 300 to achieve the pre-charge and pre-discharge effects. In this embodiment, the operating method of the N scan lines 310 of the liquid crystal display 300 is described according to four scan lines.

Scan signals SD1′″ and SD3′″ are generated by the odd scanning circuit 302, and scan signals SD2′″ and SD4′″ are generated by the even scanning circuit 304. The scan signals SD1′″ and SD3′″ control the first row of pixels and the third row of pixels in the odd-numbered rows of pixels 308a through the first scan line and the third scan line of the odd scan lines 310a, respectively. The scan signals SD2′″ and SD4′″ control the second row of pixels and the fourth row of pixels in the even-numbered rows of pixels 308b through the second scan line and the fourth scan line of the even scan lines 310b, respectively.

This embodiment divides the pixel scanning times TS of four neighboring scan lines into a predetermined voltage setting time TP′, and scan times T1′, T2′, T3′ and T4′. The scan signals SD1′″ to SD4′″ are enabled in the predetermined voltage setting time TP′. The scan signals SD1′″ to SD4′″ are enabled in the scan times T1′ to T4′, respectively. The predetermined voltage setting time TP′, the scan time T1′, the scan time T2′, the scan time T3′ and the scan time T4′ do not overlap with one another.

Each of the scan times T1′ to T4′ is shorter than the pixel scanning time TS, and the sum of the predetermined voltage setting time TP′ and the scan times T1′ to T4′ is shorter than the sum of four pixel scanning times TS. The difference between the sum of the predetermined voltage setting time TP′ and the scan times T1′ to T4′ and the sum of the four pixel scanning times TS is a saved time TR′. The actual application of the scan signals SD1′″ to SD4′″ in the liquid crystal display is described in the following drawings.

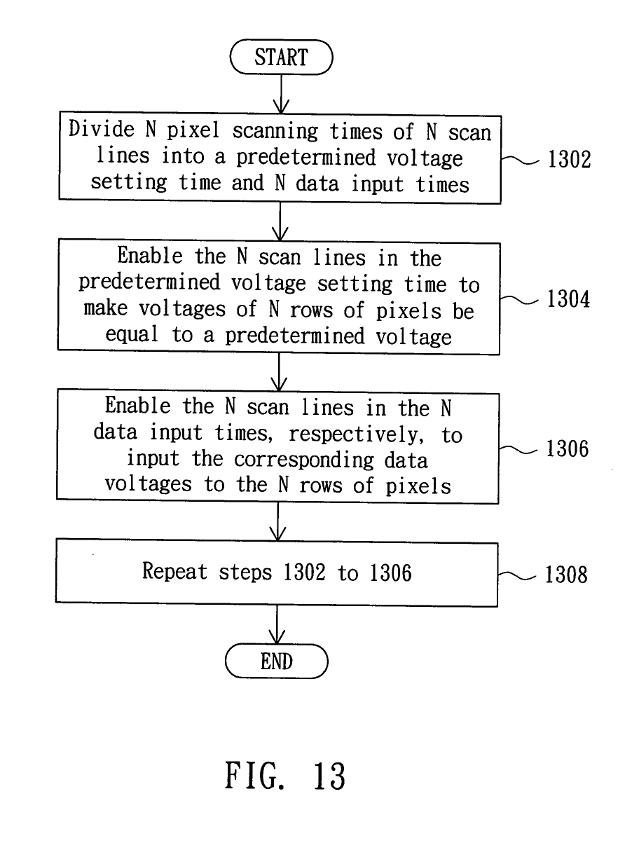

FIG. 12 shows waveforms of pixel voltages in the liquid crystal display driven by the scan signals of FIG. 11. As shown in FIG. 12, the pixel voltages SR1″ to SR4″ are the voltages at the non-common voltage terminals of the storage capacitors of the first to fourth rows of pixels. The voltages at the common voltage terminals of the storage capacitors of the liquid crystal display 300 are DC voltages with 5 volts. The initial voltages of the pixel voltages SR1″ to SR4″ are 0 volts. The data driver 306 outputs data voltages V1″ to V4″, which are 5 volts, 10 volts, 5 volts and 10 volts, respectively.

In the predetermined voltage setting time, the first scan line to the fourth scan line are enabled. At this time, the data driver 306 outputs the highest one of the data voltages V1″ to V4″. The highest data voltage charges the storage capacitors of the first to fourth rows of pixels. At this time, the pixel voltages SR1″ to SR4″ are charged from 0 volts to 10 volts.

The first to fourth scan lines are respectively enabled in the first to fourth scan times. At this time, the first to fourth scan lines charge the storage capacitors of the first to fourth rows of pixels according to the data voltages V1″ to V4″ outputted from the data driver 306, respectively. The pixel voltages SR1″ to SR4″ are driven by the data voltages V1″ to V4″ to charge or discharge to 5 volts, 10 volts, 5 volts and 10 volts, respectively.

The liquid crystal display 300 is a normal white display, for example. The odd-numbered rows of pixels 308a form the white frame, and the even-numbered rows of pixels 308b form the black frame. This liquid crystal display is a four-row inversion liquid crystal display, for example.

This embodiment divides four pixel scanning times TS of every four scan lines of the N scan lines 310 of the liquid crystal display 300 into a predetermined scan time PT′ and scan times T1′ to T4′. Four of the N scan lines 310 are grouped according to the method of dividing the scan times TS so that the corresponding four rows of pixels are scanned in the predetermined scan time PT′ and the scan times T1′ to T4′ and the effect of shortening the scanning times of the rows of the pixels can be achieved.

FIG. 13 is a flow chart showing the scan line driving method according to the third embodiment of the invention. Referring to FIG. 13, the operation flow of this embodiment is described in the following.

First, step 1302 divides the N pixel scanning times of the N scan lines into a predetermined voltage setting time and N data input times, wherein N is a natural number greater than 1.

Then, step 1304 enables the N scan lines in the predetermined voltage setting time to make the voltages of the N rows of pixels be equal to a predetermined voltage.

Furthermore, step 1306 enables the N scan lines in the N data input times so as to input the corresponding data voltages to the N rows of pixels.

Thereafter, step 1308 repeats steps 1302 to 1306.

The scan line driving method according to the embodiment of the invention enables all scan lines of the liquid crystal display in the predetermined voltage setting time so as to set the voltages of the rows of pixels of the liquid crystal display to a predetermined voltage. Thus, it is possible to shorten the operation times for charging and discharging the data voltages of the liquid crystal display, and thus to solve the problem of the incorrect data voltage level caused by the insufficient charge time in the conventional liquid crystal display, or the problem of the reduction of the aperture ratio caused by the increase of the size of the TFT.

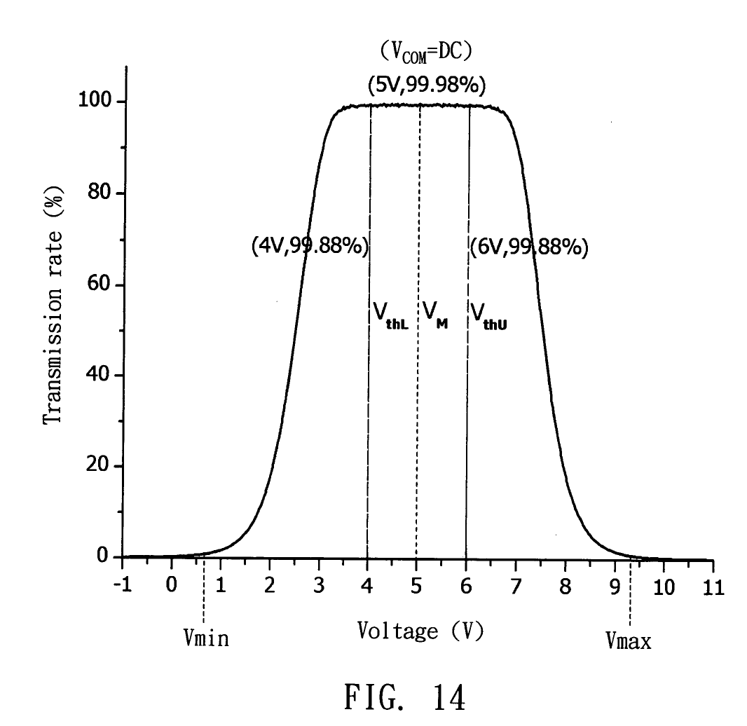

FIG. 14 shows a waveform of a Gamma curve in the driving method for the invention. The driving method of the invention lengthens the saved time TR through the setting of the Gamma curve and by limiting the positive pixel voltage to range between the positive maximum pixel voltage Vmax to the threshold voltage V_{thU} for enabling the liquid crystal to stand up (or operate), and limiting the negative polarity pixel voltage to range between the negative minimum pixel voltage Vmin to the threshold voltage V_{thL} for enabling the liquid crystal to stand up (or operate), wherein V_{thU} and V_{thL} are the threshold voltages of the liquid crystal.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A scan line driving method for dividing scan times of a first scan line and a second scan line of a liquid crystal display, the first scan line controlling a first row of pixels of the liquid crystal display, the second scan line controlling a second row of pixels of the liquid crystal display, the scan times comprising a charge time and a discharge time, the method comprising the steps of:
(a) enabling the first scan line in the charge time to drive the first row of pixels to charge;
(b) enabling the second scan line in the discharge time to drive the second row of pixels to discharge;
(c) enabling the first scan line in the discharge time to drive the first row of pixels to discharge; and
(d) enabling the second scan line in the charge time to drive the second row of pixels to charge, wherein:
the charge time is longer than the discharge time; and
the charge time and the discharge time do not overlap with each other.

2. The method according to claim 1, wherein the charging time is longer than the discharging time.

3. The method according to claim 1, wherein steps (a) to (b) and steps (c) to (d) operate in different frame scanning periods.

4. The method according to claim 1, wherein the first row of pixels and the second row of pixels have different data voltage polarities, and charge or discharge states of the first row of pixels and the second row of pixels are changed every one frame scanning period.

5. The method according to claim 1, wherein the display is a row inversion display.

6. The method according to claim 1, wherein the first scan line is driven by a driving circuit disposed on one side of a glass substrate of the liquid crystal display, and the second scan line is driven by another driving circuit disposed on the other side of the glass substrate of the liquid crystal display.

7. The method according to claim 1, wherein a pre-charge time or a pixel scanning time may be lengthened by limiting a positive pixel voltage to range between a positive maximum pixel voltage and a threshold voltage for enabling a liquid crystal to stand up (or operate), and limiting a negative polarity pixel voltage to range between a negative minimum pixel voltage and another threshold voltage for enabling the liquid crystal to stand up.

8. A scan line driving method for dividing scan times of a first scan line and a second scan line in a liquid crystal display, the first scan line controlling a first row of pixels of the liquid crystal display, the second scan line controlling a second row of pixels of the liquid crystal display, the method comprising the steps of:
(a) dividing the scan times of the first scan line and the second scan line into a predetermined voltage setting time, a first scan time and a second scan time;
(b) enabling the first scan line and the second scan line in the predetermined voltage setting time so that voltages of the first row of pixels and the second row of pixels equal a first voltage;
(c) enabling the first scan line in the first scan time to input a corresponding data voltage to the first row of pixels, and enabling the second scan line in the second scan time to input another corresponding data voltage to the second row of pixels; and
(d) repeating steps (a) to (c), wherein:
steps (b) and (d) respectively operate in different frame scanning periods of the liquid crystal display; and
the predetermined voltage setting time, the first scan time and the second scan time do not overlap with one another.

9. The method according to claim 8, wherein the first voltage in step (b) is a voltage signal higher than or equal to data voltages of the first row of pixels and the second row of pixels.

10. The method according to claim 8, wherein the liquid crystal display is a two-row inversion liquid crystal display.

11. The method according to claim 8, wherein the first scan line is driven by a driving circuit disposed on one side of a glass substrate of the liquid crystal display, and the second scan line is driven by another driving circuit disposed on the other side of the glass substrate of the liquid crystal display.

12. The method according to claim 8, wherein a pre-charge time or a pixel scanning time may be lengthened by limiting a positive pixel voltage to range between a positive maximum pixel voltage and a threshold voltage for enabling a liquid crystal to stand up (or operate), and limiting a negative polarity pixel voltage to range between a negative minimum pixel voltage and another threshold voltage for enabling the liquid crystal to stand up.

13. A scan line driving method for dividing N scan times of N scan lines in a liquid crystal display, the N scan lines respectively controlling N rows of pixels of the liquid crystal display, N being a natural number greater than 1, the method comprising the steps of:
(a) dividing the N scan times into a predetermined voltage setting time and N data input times;
(b) enabling the N scan lines in the predetermined voltage setting time to make voltages of the N rows of pixels be equal to a predetermined voltage;
(c) enabling the N scan lines respectively in the N data input times so as to input a corresponding data voltage to the N rows of pixels; and
(d) repeating steps (a) to (c), wherein:
the predetermined voltage setting time and the N data input times do not overlapped with one another.

14. The method according to claim 13, wherein the predetermined voltage in step (b) is a voltage higher than or equal to a maximum voltage of a pixel voltage of the liquid crystal display.

15. The method according to claim 13, wherein the liquid crystal display is an N-row inversion liquid crystal display.

16. The method according to claim 13, wherein the N scan lines comprise odd numbered scan lines, which are driven by a driving circuit disposed on one side of a glass substrate of the liquid crystal display, and even numbered scan lines, which are driven by another driving circuit disposed on the other side of the glass substrate of the liquid crystal display.

17. The method according to claim 13, wherein a pre-charge time or a pixel scanning time may be lengthened by limiting a positive pixel voltage to range between a positive maximum pixel voltage and a threshold voltage for enabling a liquid crystal to stand up (or operate), and limiting a negative polarity pixel voltage to range between a negative minimum pixel voltage and another threshold voltage for enabling the liquid crystal to stand up.
